(19) United States
(12) Patent Application Publication
(10) Pub. No.: US 2011/0183281 A1
(43) Pub. Date: Jul. 28, 2011

(54) CERAMIC SURFACE COATINGS FOR DENTAL APPLICATIONS

(75) Inventor: Peder Jensen, Little Rock, AR (US)

(73) Assignee: University of Arkansas

(21) Appl. No.: 12/894,866

(22) Filed: Sep. 30, 2010

Related U.S. Application Data
(63) Continuation-in-part of application No. 12/604,964, filed on Oct. 23, 2009.
(60) Provisional application No. 61/212,110, filed on Apr. 7, 2009.

(51) Int. Cl. A61C 8/00; A61C 7/20; A61C 13/02; A61C 13/00

(52) U.S. Cl. 433/18; 433/173; 433/171; 433/201.1; 433/200.1; 427/2.29; 427/2.27

(57) ABSTRACT

Disclosed herein are methodologies and compositions for coating materials, which can be used in a variety of dental applications.

### CROSS-REFERENCE TO RELATED APPLICATION

This application is a continuation-in-part of U.S. patent application Ser. No. 12/604,964, filed Oct. 23, 2009, which claims the benefit of U.S. Provisional Application No. 61/212,110, filed Apr. 7, 2009.

### INTRODUCTION

Annually, millions of implants are placed inside of organisms, including humans and animals. Most of these implants serve complex roles including but not limited to tissue replacement, mechanical support, tissue generation, cosmetic enhancement, complete or partial limb replacement, joint replacement, tooth replacement, spine reconstruction, defibrillators/pacemakers, in addition to electrodes and wires.

Because most implants are made of metals, metal oxides, polymeric materials or tissue components obtained from animals or humans, implant bio-compatibility poses a limitation in many applications as implants need to perform complex functions in the human body and their binding to the host tissue is crucial. For example, dental implants need to adhere very strongly to the jaw bone. It is also important for implant surfaces to prevent or reduce biofilm formation, which leads to infection and implant failure. To meet these requirements, implants are constructed from bio-compatible materials such as titanium, polymeric materials, or ceramic materials. Still a relatively large number of such materials are rejected every year by human patients and in most of these cases, the reasons relate to poor integration of the implant surface with the bone/tissue structure and the growth and adherence of cells at the implant surface. Furthermore, many implants are lost due to infections caused by growth of biofilm on the implant surface.

### SUMMARY

Embodiments herein include but are not limited to methods, devices, compositions, kits, materials, tools, instruments, reagents, products, compounds, pharmaceuticals, and related nutraceuticals.

In one aspect, there is provided a dental device coated with aluminum oxide, zirconia, or a combination of aluminum oxide and zirconia (ZTA). In one embodiment, the coat has a thickness between about 6 and 50 micrometers. In another embodiment, the coat has a thickness between about 6 and 40 micrometers. In another embodiment, the coat has a thickness between about 6 and 30 micrometers. In another embodiment, the coat has a thickness between about 6 and 10 micrometers.

In other embodiments, the device is coated with aluminum oxide, and has a coat with a thickness between about 6 and 50 micrometers. In another embodiment, the device is an orthodontic archwire, a partial denture clasp, dental implant, a connector used in dentistry, or an abutment. In another embodiment, the coat is deposited by thermal spray. In yet another embodiment, the device comprises a metallic substrate. In a further embodiment, the metallic substrate is titanium, titanium oxide, nickel titanium, vitallium, or chrome cobalt. In another embodiment, the coat is on at least one surface of said device.

In another aspect, there is a method for coating a dental device, comprising depositing aluminum oxide and/or zirconia on said device by ion beam deposition, electron beam deposition, pulsed laser deposition, thermal sputtering and deposition, RF sputtering, laser etching, glancing angle deposition, physical vapor deposition, molecular epitaxy, or chemical vapor deposition. In one embodiment, the device is an orthodontic archwire, a partial denture clasp, dental implant, a connector used in dentistry, or an abutment. In another embodiment, the depositing occurs by thermal sputtering.

In another aspect, there is a method for coating a dental device, comprising (1) cleaning and/or etching said dental device; and (2) depositing aluminum oxide and/or zirconia on said device by ion beam deposition, electron beam deposition, pulsed laser deposition, thermal sputtering and deposition, RF sputtering, laser etching, glancing angle deposition, physical vapor deposition, molecular epitaxy, or chemical vapor deposition. In one embodiment, the depositing occurs by thermal sputtering.

In another aspect, there is a kit for repairing a broken tooth, comprising a dental implant coated with a thin coat of aluminum oxide and/or zirconia.

In another aspect, there is a kit for straightening teeth, comprising an archwire coated with a thin coat of aluminum oxide and/or zirconia.

In another aspect, there is a denture set comprising partial denture clasps coated with aluminum oxide and/or zirconia.

In another aspect, there is an orthodontic retainer comprising a wire coated with aluminum oxide and/or zirconia.

In another aspect, there is a method for disguising a dental implant, comprising coating a dental implant with a thin coat of aluminum oxide and/or zirconia.

In another aspect, there is a kit for replacing a tooth composing an abutment coated with aluminum oxide and/or zirconia.

### BRIEF DESCRIPTION OF THE DRAWINGS

FIG. 1: Top view of a nickel titanium orthodontic arch wire coated with a thin film of ceramic using thin-film deposition techniques, resulting in improved esthetics.

FIG. 2: Front view of a nickel titanium orthodontic arch wire coated with a thin film of ceramic using thin-film deposition techniques, resulting in improved esthetics.

FIG. 3: Image of exposed metal abutement resulting from early-stage receding tissue. Exposed metal abutment creates severe cosmetic consequences (“grey gum syndrome”) for the patient. If tissue recession continues, the metal collar of the implant can also become visible, further worsening the cosmetic outcome.

FIG. 4: Dental abutment with thin white ceramic surface coating. The surface coating can be applied to the portion of the abutment which is exposed under the crown should the gums and/or bone recede after implant placement. The ceramic coating can be placed on one surface, or more than one surface, of the dental abutment. Here, the ceramic coating is placed on the facial surface.

FIG. 5: Titanium dental abutments surface coated with thin-film ceramic coatings on the collar of the abutment for improved esthetics.

FIG. 6: Dental implant with thin ceramic coating applied to the top portion of the implant to mask the metallic color should recession occur.

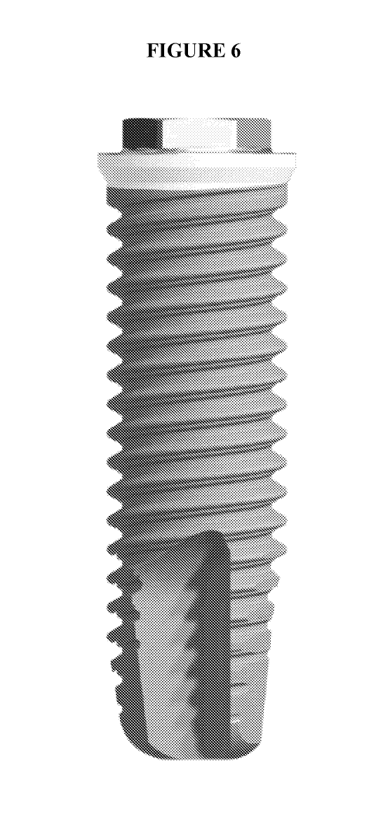

### DETAILED DESCRIPTION

The present disclosure relates to methods and compositions for dental applications, such as surface coatings for dental applications. Conventionally, dental devices, such as crowns, bridges, etc. for example, are coated with ceramic coatings, which involve baking a ceramic material onto the underlying metal implant. Such ceramic-coated devices have a surface coating (film) with a thickness measured in the millimeter range. This method of baking ceramic materials onto an underlying metal implant has proven deficient, as the present inventor discovered that baked coatings fracture under stress and are generally too thick.

Thus having identified a problem, the present inventor developed thin film deposition techniques for coating dental applications, thereby preventing coating fracture. With thin film deposition techniques, a strong mechanical bond is formed between the ceramic materials and the metallic substrate (titanium, titanium oxide, nickel titanium, chrome cobalt, etc), and thus the ceramic coating does not fracture under stress. In addition to mechanical strength and stability, the present ceramic coating is less susceptible to fracture because its has a thickness in the micrometer range, as opposed to the conventional millimeter range.

From an esthetic standpoint, the present thin coatings provides better cosmetic end results. In the dental industry, devices to replace lost or missing teeth, as well as orthodontic appliances, must be composed of a biocompatible material. These dental devices must also be strong, yet in some instances, possess elastic properties, and thus traditional metals or metal alloys are used to accomplish these tasks. However because metals and metal alloys are grey in color, the present inventor recognized advantage of coating a thin, white or colored ceramic material over the metal dental device to mask the grey metal color, thereby creating a more cosmetically acceptable dental device.

Thus, methodologies, materials, and applications provided herein concern a coating applicable to the surface of a device. More specifically, and as described below, a surface coating can be applied to any device, such as a medical or dental implant, wherein the coating is a thin-film ceramic coating having a thickness approximately in the micrometer range up to 1 millimeter. Such coating may by applied by state-of-the-art, thin-film deposition techniques including but not limited to thermal spray, ion beam deposition, laser deposition, or pulsed laser deposition.

All technical terms used herein are terms commonly used in dentistry, cell biology, biochemistry, surface chemistry, and nanotechnology and can be understood by one of ordinary skill in the relevant art.

A surface coating can be deposited on a material by any method known in the art. Non-limiting deposition methods include any one or more of ion beam deposition, electron beam deposition, pulsed laser deposition, thermal sputtering and deposition, RF sputtering, laser etching, glancing angle deposition, electrospray, chemical vapor deposition, physical vapor deposition, and molecular epitaxy. Of course, any technique by which molecules are delivered to a substrate of interest may be used. Coating can be done at the micro level or nano scale, depending on the intended use. Such methodologies are known in the art and may be found in, for example, Marc J. Madou's Fundamentals of Microfabrication, The Science of Miniaturization, 2.sup.nd Ed., including metal deposition at pages 344-357, or “Nanofabrication: Fundamentals and Applications” Ed.: Ampere A. Tseng, World Scientific Publishing Company (Mar. 4, 2008), ISBN 9812700765.

Dental device encompasses a wide variety of devices used in the dental industry and include but are not limited to orthodontic archwires, retainers (wires), dental abutments, dental implants, connectors used in dentistry, and partial denture clasps.

Although this specification provides guidance to one of ordinary skill in the art, reference to technical literature does not constitute an admission that the technical literature is prior art.

A. Coating Material

Oxide ceramics composed of oxides of alumina (aluminum) or zirconia (zirconium) are formed of small, densely-packed crystals. These pure crystals are biologically inert, and generally do not illicit an immune response in humans. Oxide ceramics are strong, hard, resistant to abrasion, and are white in color. Thus, ceramics have many potential applications in the field of cosmetic and restorative dentistry, as well as in the orthopedic implant industry for joint replacement.

As used herein, ceramic includes material oxides composed of zirconia, alumina, or a combination of zirconia and alumina (ZTA). These materials may also contain Yttrium and/or chrome oxides to provide enhanced strength and hardness. Ceramic materials are white in color and are biologically compatible, and as such, are excellent for surface coating metallic devices, such as dental devices.

While in no way limiting, the present inventor discovered that ceramic coatings made from aluminum oxide may be preferable to coatings made from zirconia, particularly as the coatings relate to dental devices. For example, and again non-limiting, it was discovered surprisingly that at the micrometer range, an alumina coating is much more opaque, or less transparent, than zirconia. Thus, and of course depending on the particular application, an aluminum oxide-coated dental device may offer better cosmetic advantages than a zirconia coating. However, the present disclosure contemplates coating with any of zirconia, alumina, and/or a combination of zirconia and alumina.

Illustrative coatings include but are not limited to opaque coatings, as well as coatings that are bio-compatible, optionally bio-degradable, and facilitates surface adherence and proliferation of cells adjacent to and/or on an implant surface. The surface coating can also deliver drugs and/or bioactive agents that can lead to increased cell proliferation and bone mineralization at the implant surface. An illustrative surface coating can be applied to any tissue matrix or implant used for any internal/medical purpose. Surface coatings can also reduce and prevent growth of a biofilm.

B. Depositing Surface Coating on a Device

A surface coating can be deposited on a material by any method known in the art. Non-limiting deposition methods include any one or more of ion beam deposition, electron beam deposition, pulsed laser deposition, thermal sputtering and deposition, RF sputtering, laser etching, glancing angle deposition, electrospray, chemical vapor deposition, physical vapor deposition, and molecular epitaxy. Of course, any technique by which molecules are delivered to a substrate of interest may be used. Coating can be done at the micro level or nano scale, depending on the intended use. Such methodologies are known in the art and may be found in, for example, Marc J. Madou's Fundamentals of Microfabrication, The Science of Miniaturization, 2.sup.nd Ed., including metal deposition at pages 344-357, or “Nanofabrication: Fundamentals and Applications” Ed.: Ampere A. Tseng, World Scientific Publishing Company (Mar. 4, 2008), ISBN 9812700765. For example, and in no way limiting, the present inventor discovered that thermal spray deposition provides better aluminum oxide coatings in the micrometer range up to 1 millimeter in thickness. In this coating size range, aluminum oxide improves the esthetic properties and qualities of dental devices. However, any other thin-film deposition technique may be used, such as ion beam deposition, laser deposition, and pulsed laser deposition.

Depending on the device surface, it may be necessary to clean and/or etch the metal surface before depositing the ceramic coating on the metal surface. Cleaning can be performed using any appropriate aqueous or solvent base cleaner that removes oil, etc. from the metal surface. Etching may be accomplished by any appropriate method known in the art, including but not limited to acid etching, grit blasting, mechanical abrasion, etc. For a given metal, an ordinarily skilled artisan would understand whether it requires etching, and if so, the appropriate etching method for the given metal.

After cleaning the metal surface, which may be optional depending on the metal, ceramic surface coatings can be applied to the metal surface using thin film atomic deposition techniques, such as thermal sputtering. In terms of thickness, ceramic surface coatings are generally in the micrometer range, from about 6 to about 10 micrometers. Parts of the material surface which are not to be coated with ceramics are masked using conventional industry standard techniques. In some embodiments, and depending on the intended use, a ceramic surface coating may have a thickness of 1, 2, 3, 4, 5, 6, 7, 8, 9, 10, 11, 12, 13, 14, 16, 17, 18, 19, 20, 22, 24, 26, 28, 30, 32, 34, 36, 38, 40, 42, 44, 46, 48, or 50 micrometers. Surface roughness can be improved if needed by conventional polishing techniques using mechanical abrasion.

D. Illustrative Products

The methods and compositions provided herein may be used in a variety of products, including but not limited to implants, devices, compositions, nutraceuticals, topicals, gels, creams, kits, reagents, implants, scaffolds, cell culture dishes, and related tools.

For example, such methods and compositions may be used to coat a variety of devices, including but not limited to an orthopedic implant, dental device, veterinary prosthetic device, graft, needle, bone material, contact lens, catheter, ear tube, endotracheal tube, stent, shunt, scaffold, tissue engineering matrix, breast implant, allograft hard tissue, allograft soft tissue, xenograft hard tissue, xenograft soft tissue, polymeric mesh, hip implant, knee implant, shoulder implant, plate, pin, screw, wire, rod, or ceramic mesh.

For instance, in the case of a dental device, any component of a dental device may be coated. Dental device components include but are not limited to an abutment and dental implant. Other dental applications include archwires, retainers, or other metal pieces used in orthodontics and removable partial denture clasps and connectors used in dentistry, all of which may be coated with a ceramic.

Specific examples are presented below. They are exemplary and not limiting, and an ordinarily skilled artisan understands that modifications and variations can be made yet retain the spirit of the disclosure.

### Example 1

### Coating Partial Denture Clasps

A thin-film ceramic coating can be deposited on a partial denture clasp. Partial dentures are an excellent, and relatively inexpensive, dental prosthesis used for replacing missing teeth. Usually, partial denture clasps are made from chrome cobalt, vitallium, or titanium nickel. These metals are strong, and have excellent elastic properties necessary for clasping teeth and dental implants to secure and stabilize the partial denture under normal wear and masticatory functions. However, partial dentures pose a significant cosmetic drawback due to the exposed metallic clasps.

As provided herein, a thin film coating of a ceramic material can be applied via atomic deposition or other thin-film deposition technique, and masks the unsightly appearance of the metallic clasps, thereby creating a more ideal cosmetic result. The white, tooth-like ceramic coating on the metallic clasps match or better blend with the color of the patient's tooth or crown to which the clasp engages. Such coated clasp would still retain its strong elastic properties, as the ceramic coating can be very thin relative to the bulk metallic clasp. The strong bonding created via thin-film deposition generates a strong mechanical bond between the ceramic material and the metal, and would not delaminate upon flexure of the partial denture clasp.

For example, a partial denture clasp can be coated with aluminum oxide by thermal spray to produce a coating having a thickness between about 6 and about 50 micrometers. Briefly, a denture clasp is first cleaned with an aqueous or solvent base to remove oils or other dirt from the metal surface. The partial denture clasp may be clamped prior to the thermal spare process. Metal surfaces not treated by this method are masked using conventional industry standards. Once cleaned, the clasp surface is roughened to improve the bond strength of the material, and can be accomplished by any method known in the art, such as grit blasting or chemical etching. The actual coating, in this case for example, is performed by thermal spray process, which provides high bond strength and uniform coat thickness. Finally, a polishing step is performed with a suitable polisher, such as but not limited to an abrasive wheel, cloth, or film.

### Example 2

### Coating Orthodontic Applications

Orthodontic archwires are generally made of metals such as nickel titanium or stainless steel, and are referred to as “shape-memory” metal alloys. These shape-memory metals are ideal materials, as their elastic properties allow the wires to move teeth during orthodontic treatment. However, one major drawback relates to the metallic appearance of the metal arch wires, which results in poor cosmetics during orthodontic treatment. To address this problem, commercial vendors have made white arch wires using a Teflon coating. However, Teflon-coated arch wires typically perform poorly, as the Teflon coating destroys most of the underlying elastic properties of the metal, and flakes or chips off during orthodontic treatment.

As provided herein, a thin film coating of a ceramic material, such as aluminum oxide, can be applied by any thin-film deposition technique to an orthodontic device to produce a coating having a thickness between about 6 and about 50 micrometers. Important for orthodontics, the thinness of a ceramic coating does not interfere with the elastic properties of the underlying metal, thereby retaining effective orthodontic capabilities. Of course, the white ceramic coating also allows for metal wires with superior esthetic properties. Furthermore, due to the strong mechanical bond between the coating and the metal wire, the coating does not delaminate under stress during orthodontic movement.

Briefly, an orthodontia metal is coated with aluminum oxide by thermal spray to produce a coating having a thickness between about 6 and about 50 micrometers. Briefly, an orthodontia metal is first cleaned with an aqueous or solvent base to remove oils or other dirty from the metal surface. Once cleaned, the archwire is clamped to prevent movement during the coating process, and once clamped, the metal surface is roughened to improve the bond strength of the material, and can be accomplished by any method known in the art, such as grit blasting or chemical etching. The actual coating, in this case for example, is performed by thermal spray process, which provides high bond strength and uniform coat thickness. If desired, the wire may be polished.

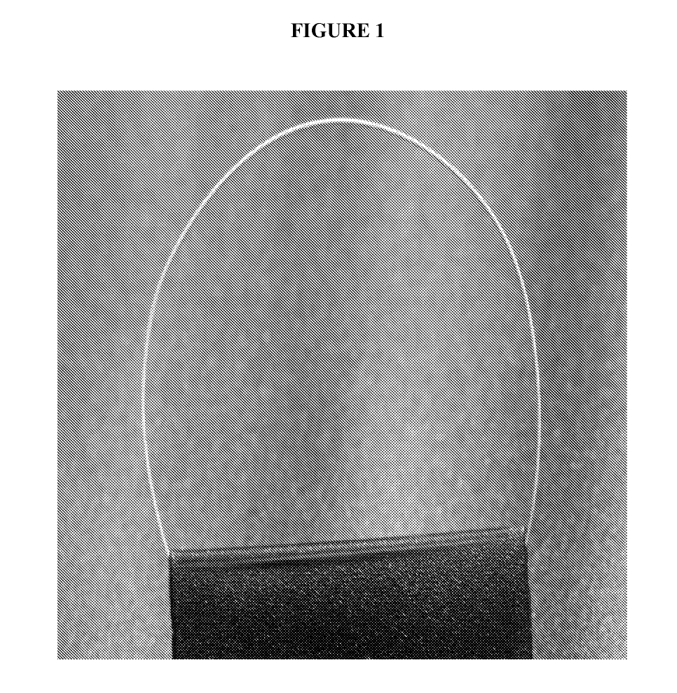

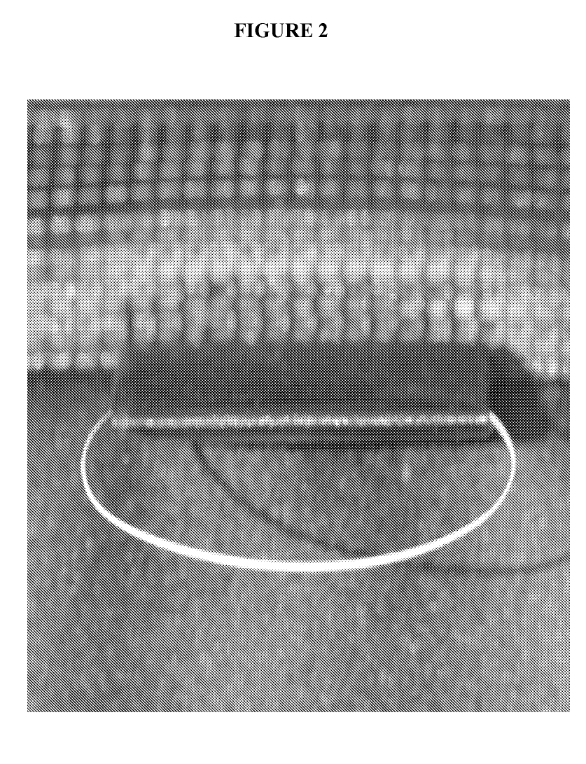

Using such methods, an orthodontia wire, for example, can be coated with aluminum oxide, for example. As shown in FIG. 1, the present methods and compositions were used to coat a nickel titanium orthodontic arch wire with a thin film of ceramic using thin-film deposition techniques, resulting in improved esthetics. FIG. 2 displays a front view of a nickel titanium orthodontic arch wire coated with a thin film of ceramic using thin-film deposition techniques, again resulting in improved esthetics.

### Example 3

### Surface-Coated Dental Implants and Abutments

Dental implants are generally constructed from titanium or medical grade titanium alloys. Implants are very useful for replacing lost or missing teeth. An abutment is inserted into the dental implant, and a crown is placed over the abutment, which forms the complete dental prosthesis. The dental implant is inserted into the bone, and covered with gingival or gum tissue. The bone gives the dental implant a strong support for mastication. The gingival tissue covers the dental implant and typically provides an excellent cosmetic result.

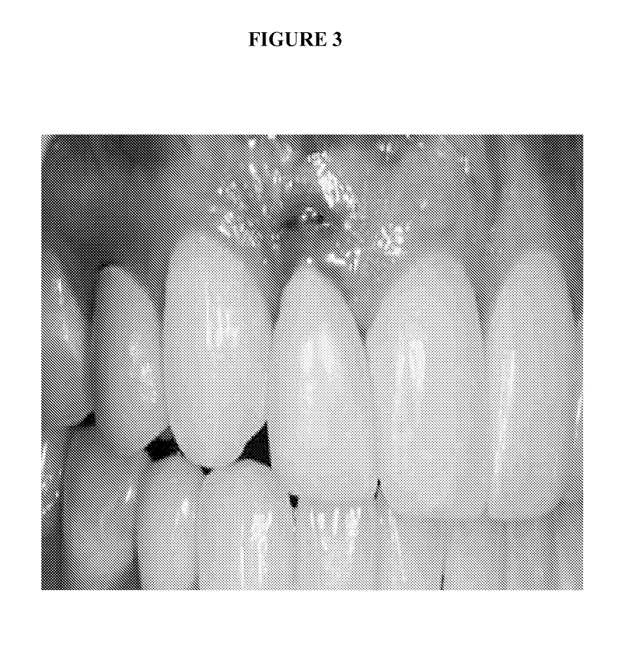

Frequently, gum and/or bone recession of a dental implant prosthesis can cause undesirable cosmetic effects. For examples, and as shown in FIG. 3, as the tissues recede, the metal of the abutment becomes exposed, creating severe cosmetic consequences (“grey gum syndrome”) for the patient. If tissue recession continues, the metal collar of the implant can also become visible, further worsening the cosmetic outcome.

Currently, implants and abutments are made from solid zirconia, which is white, or tooth-like, in color. However, solid zirconia abutments have been shown to fracture resulting from strong sheer stresses created during occlusal loading on the abutments. When the abutment fractures, the patient is faced with at least two major surgical procedures to remove the abutment and implant, bone graft the site, and then replace the implant. Then, the abutment and crown must be replaced, leading to significant expenses, lost time (up to a year), and patient inconvenience.

Furthermore, solid zirconia abutments require extensive reshaping in order to obtain an exact fit for crown placement. Because zirconia is one of the hardest materials known to man (only diamond is harder), reshaping the zirconia abutment is extremely time consuming for the dentist, and can take up to one hour. A solid zirconia one-piece implant and abutment provides no means for disguising metallic colors shown in receding gums. Furthermore, this one-piece implant and abutment is difficult and tedious to insert, as it cannot be “angled,” leading to a poor end-stage cosmetic and functional dental prosthesis.

Realizing the problems with currently available abutments, the present inventor contemplates coating an abutment and dental implant with a thin white ceramic surface coating to produce a coating having a thickness between about 6 and about 50 micrometers. The surface coating can be applied to the portion of the abutment which is exposed under the crown, should the gums and/or bone recede after implant placement. The ceramic coating can be placed on one surface, or more than one surface, of the dental abutment.

Using traditional titanium abutments, which can withstand much greater sheer forces than solid zirconia abutments, provided herein is methodology for depositing a thin film ceramic surface coating onto part, or all, of a dental abutment to prevent unsightly cosmetic problems caused by gum tissue and bone recession post-implant placement. This ceramic coating gives the abutment the white, tooth-like color in the crucial cosmetic area necessary for desirable esthetics should the gums and/or bone recede. Furthermore, the body of the abutment can be made of titanium alloy, which provides much greater strength and resistance to sheer stress under occlusal loading forces compared to zirconia abutments. Because the bulk of the abutment body is made from titanium, reshaping the abutment for crown placement is a very rapid and simple procedure for the dentist.

An abutment, or dental implant, can be coated with aluminum oxide by thermal spray, for example, to produce a coating having a thickness between about 6 and about 50 micrometers. Briefly, an abutment, or dental implant, is first cleaned with an aqueous or solvent base to remove oils or other dirty from the metal surface. Portions of the metal surface not treated by this method can be masked using industry standards. Once cleaned, the implant or abutment is clamped to prevent movement during the coating process, and once clamped, the metal surface to be coated is roughened to improve the bond strength of the material, and can be accomplished by any method known in the art, such as grit blasting or chemical etching. The actual coating, in this case for example, is performed by thermal spray process, which provides high bond strength and uniform coat thickness. Finally, a polishing step is performed with a suitable polisher, such as but not limited to an abrasive wheel, cloth, or film.

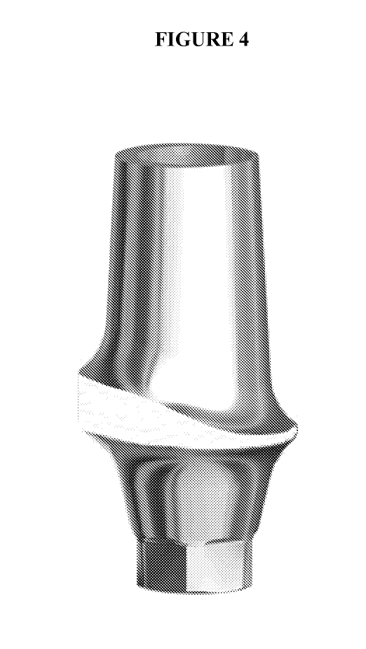

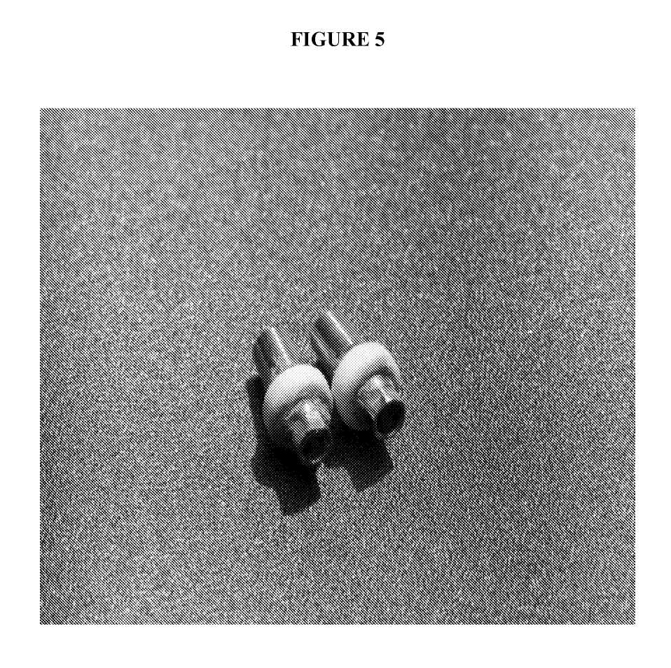

Using such methods, an abutment, or dental implant, can be coated with aluminum oxide, for example, and thereby prevent “grey gum syndrome.” As shown in FIG. 3, for example, an exposed metal abutment creates severe cosmetic consequences (“grey gum syndrome”) for the patient. If tissue recession continues, the metal collar of the implant can also become visible, further worsening the cosmetic outcome. Thus, and as shown in FIG. 4, an abutment can be coated with a thin white ceramic surface coating. Such ceramic coating can be placed on one surface, or more than one surface, of the dental abutment. In FIG. 4, for example, the ceramic coating is placed on the facial surface. Similarly, FIG. 5 displays a titanium dental abutment surface coated with thin-film ceramic coatings on the collar of the abutment for improved esthetics.

Similarly, a dental implant, or portion of a dental implant, can be coated with a thin white ceramic surface coating, to produce a coating having a thickness between about 6 and about 50 micrometers. Such ceramic coatings can be placed on one surface, or more than one surface, of the dental implant. In FIG. 5 for example, the ceramic coating is placed around the collar or cervical area of the dental implant for improved esthetics should gingival recession occur.

What is claimed is:

1. A dental device coated with aluminum oxide, zirconia, or a combination of aluminum oxide and zirconia (ZTA).

2. The dental device of claim 1, wherein said coat has a thickness between about 6 and 50 micrometers.

3. The dental device of claim 2, wherein said coat has a thickness between about 6 and 40 micrometers.

4. The dental device of claim 2, wherein said coat has a thickness between about 6 and 30 micrometers.

5. The dental device of claim 2, wherein said coat has a thickness between about 6 and 10 micrometers.

6. The dental device of claim 1, wherein said device is coated with aluminum oxide.

7. The dental device of claim 6, wherein said coat has a thickness between about 6 and 50 micrometers.

8. The dental device of claim 1, wherein said device is an orthodontic archwire, a partial denture clasp, dental implant, a connector used in dentistry, or an abutment.

9. The dental device of claim 1, wherein the coat is deposited by thermal spray.

10. The dental device of claim 1, wherein said device comprises a metallic substrate.

11. The dental device of claim 10, wherein said metallic substrate is titanium, titanium oxide, nickel titanium, vitallium, or chrome cobalt.

12. The dental device of claim 1, wherein said coat is on at least one surface of said device.

13. A method for coating a dental device, comprising:
depositing aluminum oxide and/or zirconia on said device by ion beam deposition, electron beam deposition, pulsed laser deposition, thermal sputtering and deposition, RF sputtering, laser etching, glancing angle deposition, physical vapor deposition, molecular epitaxy, or chemical vapor deposition.

14. The method of claim 13, wherein said device is an orthodontic archwire, a partial denture clasp, dental implant, a connector used in dentistry, or an abutment.

15. The method of claim 13, wherein said depositing occurs by thermal sputtering.

16. A method for coating a dental device, comprising
(1) cleaning and/or etching said dental device; and
(2) depositing aluminum oxide and/or zirconia on said device by ion beam deposition, electron beam deposition, pulsed laser deposition, thermal sputtering and deposition, RF sputtering, laser etching, glancing angle deposition, physical vapor deposition, molecular epitaxy, or chemical vapor deposition.

17. The method of claim 16, wherein said depositing occurs by thermal sputtering.

18. A kit for repairing a broken tooth, comprising a dental implant coated with a thin coat of aluminum oxide and/or zirconia.

19. A kit for straightening teeth, comprising an archwire coated with a thin coat of aluminum oxide and/or zirconia.

20. A denture set comprising partial denture clasps coated with aluminum oxide and/or zirconia.

21. An orthodontic retainer comprising a wire coated with aluminum oxide and/or zirconia.

22. A method for disguising a dental implant, comprising coating a dental implant with a thin coat of aluminum oxide and/or zirconia.

23. A kit for replacing a tooth composing an abutment coated with aluminum oxide and/or zirconia.
